(19) United States
(12) Patent Application Publication
(10) Pub. No.: US 2025/0390630 A1
(43) Pub. Date: Dec. 25, 2025

(54) JOINT OPTIMIZATION METHOD FOR TASK OFFLOADING AND CONTAINER CACHING IN CONTAINERIZED EDGE COMPUTING SYSTEM

(71) Applicant: ZHEJIANG SCI-TECH UNIVERSITY, Hangzhou City (CN)

(72) Inventors: Weiqiang XU, Hangzhou City (CN); Qi ZHANG, Hangzhou City (CN); Shuyun LUO, Hangzhou City (CN); Hezhi LUO, Hangzhou City (CN)

(73) Assignee: ZHEJIANG SCI-TECH UNIVERSITY, Hangzhou City, ZJ (CN)

(21) Appl. No.: 18/703,722

(22) PCT Filed: Jan. 15, 2024
(86) PCT No.: PCT/CN2024/072273

§ 371 Date: Jun. 9, 2025

(30) Foreign Application Priority Data
Jul. 14, 2023 (CN) 202310866632.5

(51) Int. Cl. G06F 30/20; G06F 111/10

(52) U.S. Cl. CPC G06F 30/20; G06F 2111/10

(57) ABSTRACT

The invention introduces a joint optimization technique for task offloading and container caching in containerized edge computing, within the domain of task offloading and container caching. The method involves the steps: constructing a mathematical model based on the containerized edge computing system environment, formulating a joint optimization problem using nonlinear 0-1 programming from the model, and resolving the nonlinear 0-1 programming issue. It establishes a mathematical model for the containerized edge computing system to minimize terminal device task processing time. Additionally, it presents a joint optimization approach for task offloading and container caching. This method transforms the challenging nonlinear 0-1 programming into a solvable linear 0-1 programming problem via an equivalent transformation technique. This addresses the coupling problem between caching and task offloading decisions in edge computing, thereby reducing image file download and container instance startup times in the containerized edge computing system, ultimately shortening terminal device task processing times.

### TECHNICAL FIELD

The present invention belongs to the technical field of task offloading and container caching, and particularly relates to a joint optimization method for task offloading and container caching in a containerized edge computing system.

### BACKGROUND ART

At present, two main existing joint optimization methods for task offloading and service caching in an edge computing system environment include an alternating iterative optimization method and a deep reinforcement learning method. Herein, in case of solving a coupling problem, the alternating iterative optimization method usually uses a block coordinate descent method to alternately optimize a task offloading decision and a service caching decision, which, however, will lead to a low convergence speed of an algorithm. In solving a nonconvex problem, due to limitation of block coordinate descent, alternating iterative optimization cannot find a global optimum solution for the problem well. When deep reinforcement learning solves the optimization problem, it is necessary to obtain parameters of a system in advance and train an appropriate model by building the environment. Although the model obtained by training may solve the problem quickly, due to a long training time for the model, deep reinforcement learning can only be used for an offline algorithm, which will lead to serious limitation in practical application.

### SUMMARY

The objective of the present invention is to provide a joint optimization method for task offloading and container caching in a containerized edge computing system, aiming to solve the problems of a low convergence speed and a long training time for a model in solving a coupling problem in the above technology.

In order to realize the objective, the present invention provides a joint optimization method for task offloading and container caching in a containerized edge computing system, and the method includes the following steps:
Step 1, establishing a mathematical model according to a containerized edge computing system environment;
Step 2, establishing a joint optimization problem of nonlinear 0-1 programming according to the mathematical model; and
Step 3, solving the problem of nonlinear 0-1 programming.

Preferably, the specific process of establishing a mathematical model in the Step 1 is as follows: establishing, according to feature parameters of a cloud server, an edge server, terminal devices and a container in the containerized edge computing system environment, a mathematical model with processing time of a task on the terminal devices or the edge server, time for offloading the task from the terminal devices to the edge server, time for downloading a container image file from the cloud server by the edge server, and time when a container instance is started on the edge server.

Preferably, establishing the joint optimization problem of nonlinear 0-1 programming in the Step 2 specifically includes the process as follows:
S21, establishing an expression for task execution time of the terminal device;
S22, establishing an expression for preparation time of the container instance of the edge server;
S23, establishing an expression for an optimal target function;
S24, establishing expressions for optimization problem constraints; and
S25, establishing, by satisfying the constraints in S24, a whole optimization problem with minimizing the expression for the target function in S23 as a target.

Preferably, the expression for the task execution time of the terminal devices in S21 is specifically as follows:

$${τ}^{e} ( t ) = {\sum }_{i = 1}^{I} [ ( 1 - {\sum }_{j = 1}^{J} {x}_{i , j} ( t ) ) \frac{{D}_{i} ( t ) {ρ}_{i}}{{F}_{i}^{d}} + {\sum }_{j = 1}^{J} {x}_{i , j} ( t ) \frac{{D}_{i} ( t ) {ρ}_{i}}{{F}_{j}^{e}} ]$$

where τ^{e}(t) represents the task execution time of all the terminal devices; x_{i,j}(t) ∈{0,1} represents a task offloading decision; Dᵢ(t) represents a task load generated by a terminal device i during a time slot t; ρᵢ represents computational complexity of a task generated by the terminal device i;

$${F}_{i}^{d}$$

represents a computational frequency of the terminal device i;

$${F}_{j}^{e}$$

represents a computational frequency of the edge server j; I represents the number of the terminal devices; and J represents the number of the edge servers.

Preferably, the preparation time of the container instance of the edge server in S22 includes task offloading time, container instance starting time and container image file downloading time,
the task offloading time of the terminal devices during the time slot t is expressed as:

$${τ}^{u} ( t ) = {\sum }_{j = 1}^{J} {\sum }_{i = 1}^{I} {x}_{i , j} ( t ) \frac{{D}_{i} ( t )}{{R}_{i , j}^{u}} \qquad ( 1 )$$

the container instance starting time of the edge server during the time slot t is expressed as:

$${τ}^{s} ( t ) = {\sum }_{j = 1}^{J} {\sum }_{i = 1}^{I} {x}_{i , j} ( t ) ( 1 - {y}_{i , j} ( t ) ) {\sum }_{s = 1}^{S} {ξ}_{i , s} {θ}_{s} \qquad ( 2 )$$

the container image file downloading time of the edge server during the time slot t is expressed as:

$${τ}^{d} ( t ) = {\sum }_{j = 1}^{J} {\sum }_{i = 1}^{I} {x}_{i , j} ( t ) ( 1 - {y}_{i , j} ( t ) ) ( 1 - {z}_{i , j} ( t ) ) \frac{{\sum }_{s = 1}^{S} {ξ}_{i , s} {λ}_{s}}{{R}_{j}^{d}} \qquad ( 3 )$$

where τ^{u} (t) represents the task offloading time of the terminal devices during the time slot t; I represents the number of the terminal devices; J represents the number of the edge servers; x_{i,j}(t) ∈{0,1} represents the task offloading decision; Dᵢ(t) represents the task load generated by the terminal device i during the time slot t;

$${R}_{i , j}^{u}$$

represents a transmission rate of the terminal device i during offloading the task to the edge server j; τ^{s}(t) represents the container instance starting time of the edge server during the time slot t; y_{i,j}(t) ∈{0,1} represents a container instance caching decision; ξ_{i,s} ∈{0,1} represents whether the task of the terminal device i requires an image file s; θₛ represents time of the image file s during starting the container instance; τ^{d} (t) represents the container image file downloading time of the edge server during the time slot t; z_{i,j}(t) ∈{0,1} represents an image file caching decision; λₛ represents a size of the image file s;

$${R}_{j}^{d}$$

represents a rate of the edge server j during downloading the image file from the cloud server; and S represents the number of the image files.

Preferably, the expression for an optimal target function in S23 is specifically as follows:

$${τ}^{sum} ( t ) = {τ}^{e} ( t ) + {τ}^{u} ( t ) + {τ}^{s} ( t ) + {τ}^{d} ( t ) \qquad ( 4 )$$

where τ^{e}(t) represents the task execution time of all the terminal devices; τ^{u}(t) represents the task offloading time of the terminal devices during the time slot t; τ^{s}(t) represents the container instance starting time of the edge server during the time slot t; and τ^{d} (t) represents the container image file downloading time of the edge server during the time slot t.

Preferably, the optimization problem constraints in S24 include a task offloading decision variable constraint, a cache capacity constraint of the container instance of the edge server, a cache capacity constraint of the container image file of the edge server, a caching decision logic constraint of the edge server and a 0-1 variable constraint;
the task offloading decision variable constraint is expressed as:

$${\sum }_{j = 1}^{J} {x}_{i , j} \leq 1 , ∀ i ∈ 𝕀$$

the cache capacity constraint of the container instance of the edge server is expressed as:

$${\sum }_{i = 1}^{I} {\sum }_{s = 1}^{S} {y}_{i , j} ( t ) {ξ}_{i , s} {η}_{s} \leq {η}_{j}^{max} , ∀ j ∈ 𝕁$$

the cache capacity constraint of the container image file of the edge server is expressed as:

$${\sum }_{i = 1}^{I} {\sum }_{s = 1}^{S} {z}_{i , j} ( t ) {ξ}_{i , s} {λ}_{s} \leq {λ}_{j}^{max} , ∀ j ∈ 𝕁$$

the caching decision logic constraint of the edge server is expressed as:

$$\begin{matrix}{y}_{i , j} ( t ) \leq {y}_{i , j} ( t - 1 ) + {x}_{i , j} ( t - 1 ) , ∀ i ∈ 𝕀 , j ∈ 𝕁 \\ {z}_{i , j} ( t ) \leq {z}_{i , j} ( t - 1 ) + {x}_{i , j} ( t - 1 ) ( 1 - {y}_{i , j} ( t - 1 ) ) , ∀ i ∈ 𝕀 , j ∈ 𝕁\end{matrix}$$

the 0-1 variable constraint is expressed as:

$${x}_{i , j} ( t ) , {y}_{i , j} ( t ) , {z}_{i , j} ( t ) ∈ \{ 0 , 1 \} , ∀ i ∈ 𝕀 , j ∈ 𝕁$$

where y_{i,j}(t) ∈{0,1} represents the container instance caching decision; ξ_{i,s} ∈{0,1} represents whether the task of the terminal device i requires the image file s; ηₛ represents the size of RAM occupied by the container instance started by the image file s;

$${η}_{j}^{max}$$

represents a maximal container instance cache capacity of the jth edge server; z_{i,j}(t) ∈{0,1} represents the image file caching decision; λₛ represents the size of the image file s;

$${λ}_{j}^{max}$$

represents a maximal image file cache capacity of the jth edge server; [symbol] ={1,2,3, . . . , I} represents a terminal device set; and [symbol] ={1,2,3, . . . , J} represents an edge server set.

Preferably, solving the problem of nonlinear 0-1 programming in the Step 3 includes the specific process as follows:
S31, forming, by introducing three equality constraints, a new target function on the basis of the target function;
S32, transforming the three equality constraints into nine new inequality constraints by introducing equivalent transformation; and
S33, solving, by a solver or a linear integer programming algorithm, the transformed problem of linear 0-1 programming according to the new target function and the nine new inequality constraints in the Steps S31 and S32, in combination with six inequality constraints in an original target function.

Preferably, the three equality constraints in S31 are specifically as follows:

$${p}_{i , j} ( t ) = {x}_{i , j} ( t ) {y}_{i , j} ( t ) \qquad ( 5 )$$

$${q}_{i , j} ( t ) = {x}_{i , j} ( t ) {z}_{i , j} ( t ) \qquad ( 6 )$$

$${l}_{i , j} ( t ) = {p}_{i , j} ( t ) {z}_{i , j} ( t ) \qquad ( 7 )$$

according to the formulas (1), (2), (3), (4), (5), (6) and (7), the new target function is obtained as follows:

$$\begin{matrix}{τ}^{{sum}^{'}} ( t ) = {\sum }_{i = 1}^{I} {A}_{i} ( t ) + {\sum }_{j = 1}^{J} {\sum }_{i = I}^{I} {B}_{i , j} ( t ) {x}_{{i}_{,} j} ( t ) + {\sum }_{j = 1}^{J} {\sum }_{i = 1}^{I} {C}_{i , j} ( t ) {p}_{i , j} ( t ) + {\sum }_{j = 1}^{J} {\sum }_{i = 1}^{I} {D}_{i , j} ( t ) {q}_{i , j} ( t ) + {\sum }_{j = 1}^{J} {\sum }_{i = 1}^{I} {E}_{i , j} ( t ) {l}_{i , j} ( t ) \\ where {A}_{i} ( t ) = \frac{{D}_{i} ( t ) {ρ}_{i}}{{F}_{i}^{d}} , {B}_{i , j} ( t ) = - \frac{{D}_{i} ( t ) {ρ}_{i}}{{F}_{i}^{d}} + \frac{{D}_{i} ( t ) {ρ}_{i}}{{F}_{j}^{e}} + \frac{{D}_{i} ( t )}{{R}_{i , j}^{u}} + {\sum }_{s = 1}^{S} {ξ}_{i , s} {θ}_{s} + \frac{{\sum }_{s = 1}^{S} {ξ}_{i , s} {λ}_{s}}{{R}_{j}^{d}} , \\ {C}_{i , j} ( t ) = - {\sum }_{s = 1}^{S} {ξ}_{i , s} {θ}_{s} - \frac{{\sum }_{s = 1}^{S} {ξ}_{i , s} {λ}_{s}}{{R}_{j}^{d}} , {D}_{i , j} ( t ) = - \frac{{\sum }_{s = 1}^{S} {ξ}_{i , s} {λ}_{s}}{{R}_{j}^{d}} , {E}_{i , j} ( t ) = \frac{{\sum }_{s = 1}^{S} {ξ}_{i , s} {λ}_{s}}{{R}_{j}^{d}} , {x}_{i , j} ( t ) ∈ \{ 0 , 1 \}\end{matrix}$$

represents the task offloading decision; y_{i,j} (t) ∈{0,1} represents the container instance caching decision; z_{i,j}(t) ∈{0,1} represents the image file caching decision; p_{i,j}, q_{i,j}, l_{i,j} ∈{0,1}, ∀i ∈ [symbol] , j ∈ [symbol] , [symbol] ={1,2,3, . . . , I} represents the terminal device set; [symbol] ={1,2,3, . . . , J} represents the edge server set.

Preferably, equivalent transformation in S32 is specifically as follows: for any a, b, c ∈{0,1}, three inequality constraints c≤a, c≤b and a+b−1≤c are equivalent to an equality constraint c=a*b;
the nine new inequality constraints are specifically as follows:

$$\begin{matrix}{p}_{i , j} ( t ) \leq {x}_{i , j} ( t ) , ∀ i ∈ 𝕀 , j ∈ 𝕁 \\ {p}_{i , j} ( t ) \leq {y}_{i , j} ( t ) , ∀ i ∈ 𝕀 , j ∈ 𝕁 \\ {x}_{i , j} ( t ) + {y}_{i , j} ( t ) - 1 \leq {p}_{i , j} ( t ) , ∀ i ∈ 𝕀 , j ∈ 𝕁 \\ {q}_{i , j} ( t ) \leq {x}_{i , j} ( t ) , ∀ i ∈ 𝕀 , j ∈ 𝕁 \\ {q}_{i , j} ( t ) \leq {z}_{i , j} ( t ) , ∀ i ∈ 𝕀 , j ∈ 𝕁 \\ {x}_{i , j} ( t ) + {z}_{i , j} ( t ) - 1 \leq {q}_{i , j} ( t ) , ∀ i ∈ 𝕀 , j ∈ 𝕁 \\ {l}_{i , j} ( t ) \leq {p}_{i , j} ( t ) , ∀ i ∈ 𝕀 , j ∈ 𝕁 \\ {l}_{i , j} ( t ) \leq {z}_{i , j} ( t ) , ∀ i ∈ 𝕀 , j ∈ 𝕁 \\ {p}_{i , j} ( t ) + {z}_{i , j} ( t ) - 1 \leq {l}_{i , j} ( t ) , ∀ i ∈ 𝕀 , j ∈ 𝕁\end{matrix}$$

where x_{i,j} (t) ∈{0,1} represents the task offloading decision; y_{i,j}(t) ∈{0,1} represents the container instance caching decision; and z_{i,j}(t) ∈{0,1} represents the image file caching decision.

Therefore, the present invention uses the joint optimization method for task offloading and container caching in a containerized edge computing system, and the method has the following beneficial effects that the originally difficult problem of nonlinear 0-1 programming is transformed into an easy-to-solve problem of linear 0-1 programming by an equivalent transformation method, thereby solving the problem of coupling between the caching decision and the task offloading decision in edge computing, shortening the image file downloading time and the container instance starting time in the containerized edge computing system, and then shortening the task processing time of the terminal device.

Below, a further detailed description of the technical solution of the present invention will be provided through the accompanying drawings and embodiments.

### BRIEF DESCRIPTION OF THE DRAWINGS

FIG. 1 is a scene graph of a containerized edge computing system of the present invention;

FIG. 2 is a schematic diagram of a containerized edge server and a cloud server of the present invention; and

FIG. 3 is an execution flowchart of an algorithm in an application of the present invention.

### DETAILED DESCRIPTION OF THE EMBODIMENTS

### Embodiment

The following detailed description of the embodiments of the present invention, as presented in the drawings, is not intended to limit the scope of the present invention, as claimed, but is merely representative of selected embodiments of the present invention. Based on the embodiments of the present invention, all the other embodiments obtained by those of ordinary skilled in the art without inventive effort are within the scope of the protection of the present invention.

A joint optimization method for task offloading and container caching in a containerized edge computing system includes the following steps:
Step 1, establishing a mathematical model according to a containerized edge computing system environment; and establishing, according to feature parameters of a cloud server, an edge server, terminal devices and a container in the containerized edge computing system environment, a mathematical model with processing time of a task on the terminal devices or the edge server, time for offloading the task from the terminal devices to the edge server, time for downloading a container image file from the cloud server by the edge server, and time when a container instance is started on the edge server;
Step 2, establishing a joint optimization problem of nonlinear 0-1 programming according to the above mathematical model, including the following specific process:

S21, establishing an expression for task execution time of the terminal device, where the specific expression is as follows:

$${τ}^{e} ( t ) = {\sum }_{i = 1}^{I} [ ( 1 - {\sum }_{j = 1}^{J} {x}_{i , j} ( t ) ) \frac{{D}_{i} ( t ) {ρ}_{i}}{{F}_{i}^{d}} + {\sum }_{j = 1}^{J} {x}_{i , j} ( t ) \frac{{D}_{i} ( t ) {ρ}_{i}}{{F}_{j}^{e}} ]$$

where τ^{e}(t) represents the task execution time of all the terminal devices; x_{i,j}(t) ∈{0,1} represents a task offloading decision; Dᵢ(t) represents a task load generated by a terminal device i during a time slot t; ρᵢ represents computational complexity of a task generated by the terminal device i;

$${F}_{i}^{d}$$

represents a computational frequency of the terminal device i;

$${F}_{j}^{e}$$

represents a computational frequency of the edge server j; I represents the number of the terminal devices; and J represents the number of the edge servers;
S22, establishing an expression for preparation time of the container instance of the edge server, where the preparation time of the container instance of the edge server includes task offloading time, container instance starting time and container image file downloading time,
the task offloading time of the terminal devices during the time slot t is expressed as:

$${τ}^{u} ( t ) = {\sum }_{j = 1}^{J} {\sum }_{i = 1}^{I} {x}_{i , j} ( t ) \frac{{D}_{i} ( t )}{{R}_{i , j}^{u}} \qquad ( 1 )$$

the container instance starting time of the edge server during the time slot t is expressed as:

$${τ}^{s} ( t ) = {\sum }_{j = 1}^{J} {\sum }_{i = 1}^{I} {x}_{i , j} ( t ) ( 1 - {y}_{i , j} ( t ) ) {\sum }_{s = 1}^{S} {ξ}_{i , s} {θ}_{s} \qquad ( 2 )$$

the container image file downloading time of the edge server during the time slot t is expressed as:

$${τ}^{d} ( t ) = {\sum }_{j = 1}^{J} {\sum }_{i = 1}^{I} {x}_{i , j} ( t ) ( 1 - {y}_{i , j} ( t ) ) ( 1 - {z}_{i , j} ( t ) ) \frac{{\sum }_{s = 1}^{S} {ξ}_{i , s} {λ}_{s}}{{R}_{j}^{d}} \qquad ( 3 )$$

where τ^{u} (t) represents the task offloading time of the terminal devices during the time slot t; I represents the number of the terminal devices; J represents the number of the edge servers; x_{i,j}(t) ∈{0,1} represents the task offloading decision; Dᵢ(t) represents the task load generated by the terminal device i during the time slot t;

$${R}_{i , j}^{u}$$

represents a transmission rate of the terminal device i during offloading the task to the edge server j; τ^{s}(t) represents the container instance starting time of the edge server during the time slot t; y_{i,j}(t) ∈{0,1} represents a container instance caching decision; ξ_{i,s} ∈{0,1} represents whether the task of the terminal device i requires an image file s; θₛ represents time of the image file s during starting the container instance; τ^{d} (t) represents the container image file downloading time of the edge server during the time slot t; z_{i,j}(t) ∈{0,1} represents an image file caching decision; λₛ represents a size of the image file s;

$${R}_{j}^{d}$$

represents a rate of the edge server j during downloading the image file from the cloud server;
S23, establishing an expression for an optimal target function, where the specific expression is as follows:

$${τ}^{sum} ( t ) = {τ}^{e} ( t ) + {τ}^{u} ( t ) + {τ}^{s} ( t ) + {τ}^{d} ( t ) \qquad ( 4 )$$

where τ^{e}(t) represents the task execution time of all the terminal devices; τ^{u}(t) represents the task offloading time of the terminal devices during the time slot t; τ^{s}(t) represents the container instance starting time of the edge server during the time slot t; and τ^{d} (t) represents the container image file downloading time of the edge server during the time slot t;
S24, establishing expressions for optimization problem constraints, where the optimization problem constraints include a task offloading decision variable constraint, a cache capacity constraint of the container instance of the edge server, a cache capacity constraint of the container image file of the edge server, a caching decision logic constraint of the edge server and a 0-1 variable constraint, where
the task offloading decision variable constraint is expressed as:

$${\sum }_{j = 1}^{J} {x}_{i , j} \leq 1 , ∀ i ∈ 𝕀$$

the cache capacity constraint of the container instance of the edge server is expressed as:

$${\sum }_{i = 1}^{I} {\sum }_{s = 1}^{S} {y}_{i , j} ( t ) {ξ}_{i , s} {η}_{s} \leq {η}_{j}^{max} , ∀ j ∈ 𝕁$$

the cache capacity constraint of the container image file of the edge server is expressed as:

$${\sum }_{i = 1}^{I} {\sum }_{s = 1}^{S} {z}_{i , j} ( t ) {ξ}_{i , s} {λ}_{s} \leq {λ}_{j}^{max} , ∀ j ∈ 𝕁$$

the caching decision logic constraint of the edge server is expressed as:

$$\begin{matrix}{y}_{i , j} ( t ) \leq {y}_{i , j} ( t - 1 ) + {x}_{i , j} ( t - 1 ) , ∀ i ∈ 𝕀 , j ∈ 𝕁 \\ {z}_{i , j} ( t ) \leq {z}_{i , j} ( t - 1 ) + {x}_{i , j} ( t - 1 ) ( 1 - {y}_{i , j} ( t - 1 ) ) , ∀ i ∈ 𝕀 , j ∈ 𝕁\end{matrix}$$

the 0-1 variable constraint is expressed as:

$${x}_{i , j} ( t ) , {y}_{i , j} ( t ) , {z}_{i , j} ( t ) ∈ \{ 0 , 1 \} , ∀ i ∈ 𝕀 , j ∈ 𝕁$$

where y_{i,j}(t) ∈{0,1} represents the container instance caching decision; is ξ_{i,s} ∈{0,1} represents whether the task of the terminal device i requires the image file s; η₃ represents the size of RAM occupied by the container instance started by the image file s;

$${η}_{j}^{max}$$

represents a maximal container instance cache capacity of the jth edge server; z_{i,j}(t) ∈{0,1} represents the image file caching decision; X, represents the size of the image file s;

$${λ}_{j}^{max}$$

represents a maximal image file cache capacity of the jth edge server; [symbol] ={1,2,3, . . . , I} represents a terminal device set; and [symbol] ={1,2,3, . . . , J} represents an edge server set;
S25, establishing, by satisfying the constraints in S24, a whole optimization problem with minimizing the expression for the target function in S23 as a target;
Step 3, solving the problem of nonlinear 0-1 programming, including the specific process as follows:

S31, forming, by introducing three equality constraints, a new target function on the basis of the target function, where the three equality constraints are specifically as follows:

$${p}_{i , j} ( t ) ( t ) = {x}_{i , j} ( t ) {y}_{i , j} ( t ) \qquad ( 5 )$$

$${q}_{i , j} ( t ) = {x}_{i , j} ( t ) {z}_{i , j} ( t ) \qquad ( 6 )$$

$${l}_{i , j} ( t ) = {p}_{i , j} ( t ) {z}_{i , j} ( t ) \qquad ( 7 )$$

according to the formulas (1), (2), (3), (4), (5), (6) and (7), the new target function is obtained as follows:

$$\begin{matrix}{τ}^{{sum}^{'}} ( t ) = {\sum }_{i = 1}^{I} {A}_{i} ( t ) + {\sum }_{j = 1}^{J} {\sum }_{i = 1}^{I} {B}_{i , j} ( t ) {x}_{i , j} ( t ) + {\sum }_{j = 1}^{J} {\sum }_{i = 1}^{I} {C}_{i , j} ( t ) {p}_{i , j} ( t ) + {\sum }_{j = 1}^{J} {\sum }_{i = 1}^{I} {D}_{i , j} ( t ) {q}_{i , j} ( t ) + {\sum }_{j = 1}^{𝕁} {\sum }_{i = 1}^{𝕀} {E}_{i , j} ( t ) {l}_{i , j} ( t ) \\ where {A}_{i} ( t ) = \frac{{D}_{i} ( t ) {ρ}_{i}}{{F}_{i}^{d}} , {B}_{i , j} ( t ) = - \frac{{D}_{i} ( t ) {ρ}_{i}}{{F}_{i}^{d}} + \frac{{D}_{i} ( t ) {ρ}_{i}}{{F}_{j}^{e}} + \frac{{D}_{i} ( t )}{{R}_{i , j}^{u}} + \frac{{D}_{i} ( t )}{{R}_{i , j}^{u}} + {\sum }_{s = 1}^{S} {ξ}_{i , s} {θ}_{s} + \frac{{\sum }_{s = 1}^{S} {ξ}_{i , s} {λ}_{s}}{{R}_{j}^{d}} , \\ {C}_{i , j} ( t ) = - {\sum }_{s = 1}^{s} {ξ}_{i , s} {θ}_{s} - \frac{{\sum }_{s = 1}^{S} {ξ}_{i , s} {λ}_{s}}{{R}_{j}^{d}} , {D}_{i , j} ( t ) = - \frac{{\sum }_{s = 1}^{S} {ξ}_{i , s} {λ}_{s}}{{R}_{j}^{d}} , {E}_{i , j} ( t ) = \frac{{\sum }_{s = 1}^{S} {ξ}_{i , s} {λ}_{s}}{{R}_{j}^{d}} ,\end{matrix}$$

x_{i,j}(t) ∈{0,1} represents the task offloading decision; y_{i,j}(t) ∈{0,1} represents the container instance caching decision; z_{i,j}(t) ∈{0,1} represents the image file caching decision; p_{i,j}, q_{i,j}, l_{i,j}, ∈{0,1}, ∀i ∈ [symbol] , j ∈ [symbol] , [symbol] ={1,2,3, . . . , I} represents the terminal device set; [symbol] ={1,2,3, . . . , J} represents the edge server set;

S32, transforming the three equality constraints into nine new inequality constraints by introducing equivalent transformation, where equivalent transformation is specifically as follows: for any a, b, c ∈{0,1}, three inequality constraints c≤a, c≤b and a+b−1≤c are equivalent to an equality constraint c=a*b; and
the nine new inequality constraints are specifically as follows:

$$\begin{matrix}{p}_{i , j} ( t ) \leq {x}_{i , j} ( t ) , ∀ i ∈ 𝕀 , j ∈ 𝕁 \\ {p}_{i , j} ( t ) \leq {y}_{i , j} ( t ) , ∀ i ∈ 𝕀 , j ∈ 𝕁 \\ {x}_{i , j} ( t ) + {y}_{i , j} ( t ) - 1 \leq {p}_{i , j} ( t ) , ∀ i ∈ 𝕀 , j ∈ 𝕁 \\ {q}_{i , j} ( t ) \leq {x}_{i , j} ( t ) , ∀ i ∈ 𝕀 , j ∈ 𝕁 \\ {q}_{i , j} ( t ) \leq {z}_{i , j} ( t ) , ∀ i ∈ 𝕀 , j ∈ 𝕁 \\ {x}_{i , j} ( t ) + {z}_{i , j} ( t ) - 1 \leq {q}_{i , j} ( t ) , ∀ i ∈ 𝕀 , j ∈ 𝕁 \\ {l}_{i , j} ( t ) \leq {p}_{i , j} ( t ) , ∀ i ∈ 𝕀 , j ∈ 𝕁 \\ {l}_{i , j} ( t ) \leq {z}_{i , j} ( t ) , ∀ i ∈ 𝕀 , j ∈ 𝕁 \\ {p}_{i , j} ( t ) + {z}_{i , j} ( t ) - 1 \leq {l}_{i , j} ( t ) , ∀ i ∈ 𝕀 , j ∈ 𝕁\end{matrix}$$

where x_{i,j} (t) ∈{0,1} represents the task offloading decision; y_{i,j}(t) ∈{0,1} represents the container instance caching decision; and z_{i,j} (t) ∈{0,1} represents the image file caching decision; and
S33, solving, by a solver or a linear integer programming algorithm, the transformed problem of linear 0-1 programming according to the new target function and the nine new inequality constraints in the Steps S31 and S32, in combination with six inequality constraints in an original target function.

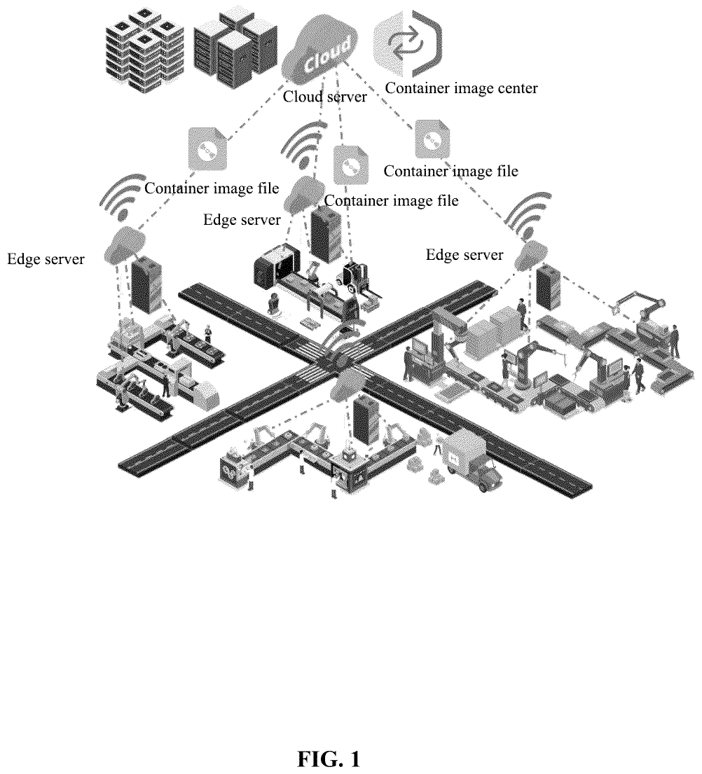

As shown in FIG. 1, a scene consisting of three layers that are a cloud server layer, an edge server layer, and a terminal device layer, is considered. It is assumed that there is a cloud server in the cloud server layer, there are J edge servers in the edge server layer, and I terminal devices in the terminal device layer. An application program that executes a task on the edge server is a container instance, and is started by the corresponding container image file. All container image files used for starting the container instance are stored in the cloud server. In a case that when the task is executed on the edge server, the edge server needs to pull the container image file from the cloud server and then start the container instance. Caching the container instance and the container image file on the edge server can shorten a container preparation time.

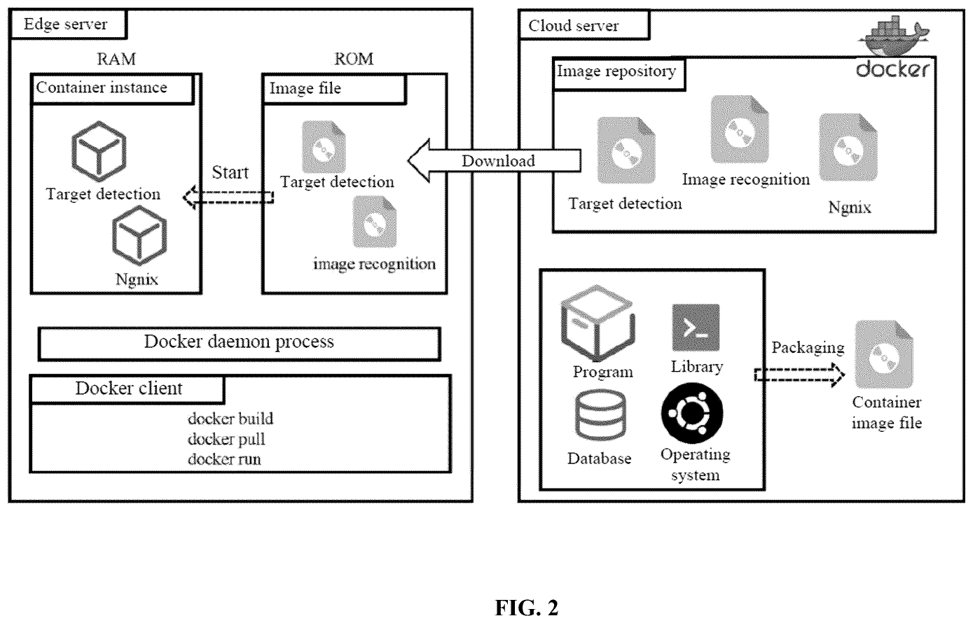

As shown in FIG. 2, a Docker technology is introduced into an edge computing system, and the container-based edge server and the container-based cloud server are proposed. On the container-based cloud server, all environments (all necessary components such as a library, a framework, and other dependencies) required by a program for processing the task and a running program may be packaged into a container image file. There is a container image file library, which stores all the image files required to process the task of the terminal device, on the cloud server. On the container-based edge server, a Docker client may download the container image file from a repository of the cloud server; and then, a Docker daemon process on the edge server may start the image file into the corresponding container instance which provides a service for processing the task of the terminal device. It is considered that downloading the container image file and starting the container instance are time-consuming. Therefore, the time consumption is reduced by caching the container image file and the container instance in ROM and RAM of the edge server respectively.

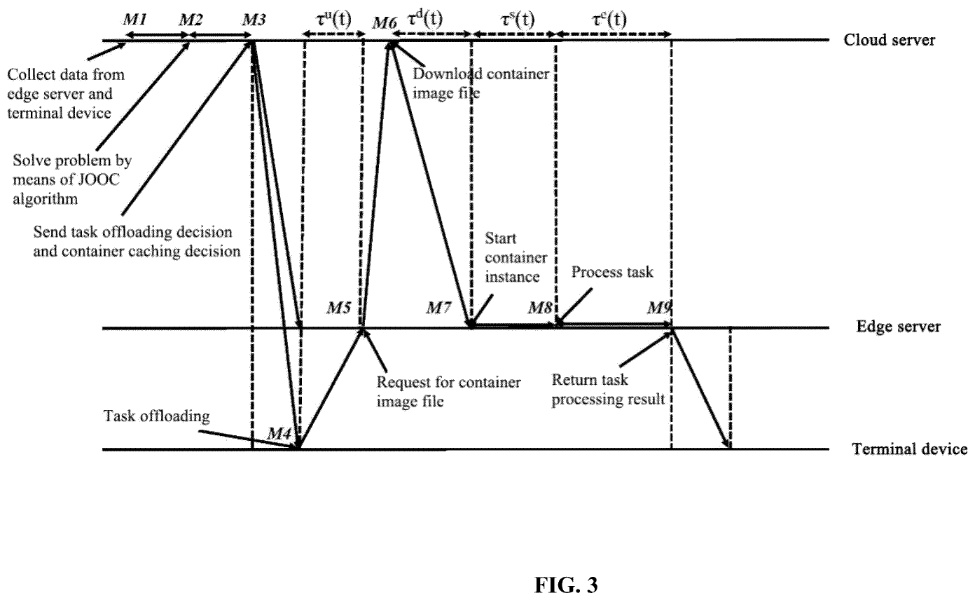

As shown in FIG. 3, it describes application of the algorithm in an actual scene. The cloud server collects data from the edge server and the terminal devices at time M1; and then, the JOOC algorithm proposed herein is used to solve the task offloading decision and the container caching decision at time M2. Then, the cloud server sends task offloading and container caching commands to the edge server and the terminal devices at time M3. The terminal devices offload the task to the edge server at time M4. The edge server sends a request to the cloud server at time M5 to download the required container image file. The cloud server sends the container image file to the edge server at time M6. The edge server starts the container instance at time M7. The edge server processes the task offloaded by the terminal devices at time M8, and then, returns a task processing result to the terminal devices at time M9.

Therefore, the present invention uses the joint optimization method for task offloading and container caching in a containerized edge computing system, in which the originally difficult problem of nonlinear 0-1 programming is transformed into an easy-to-solve problem of linear 0-1 programming by an equivalent transformation method, thereby solving the problem of coupling between the caching decision and the task offloading decision in edge computing, shortening the image file downloading time and the container instance starting time in the containerized edge computing system, and then shortening the task processing time of the terminal device.

Finally, it should be noted that the above embodiments are merely used for illustration of the technical solutions of the present invention, but not limit them. Although the present invention has been described in detail with reference to the preferred examples, those of ordinary skilled in the art should understand that: modifications or equivalent substitutions may still be made on the technical solutions of the present invention, and they do not make the modified technical solutions depart from the spirit and the scope of the technical solutions of the present invention.

What is claimed is:

1. A joint optimization method for task offloading and container caching in a containerized edge computing system, comprising the following steps:
Step 1, establishing a mathematical model according to a containerized edge computing system environment;
Step 2, establishing a joint optimization problem of nonlinear 0-1 programming according to the mathematical model; and
Step 3, solving the problem of nonlinear 0-1 programming.

2. The joint optimization method for task offloading and container caching in a containerized edge computing system according to claim 1, wherein establishing the mathematical model in the Step 1 specifically comprises the process as follows: establishing, according to feature parameters of a cloud server, an edge server, terminal devices and a container in the containerized edge computing system environment, the mathematical model with processing time of a task on the terminal devices or the edge server, time for offloading the task from the terminal devices to the edge server, time for downloading a container image file from the cloud server by the edge server, and time when a container instance is started on the edge server.

3. The joint optimization method for task offloading and container caching in a containerized edge computing system according to claim 1, wherein establishing the joint optimization problem of nonlinear 0-1 programming in the Step 2 specifically comprises the process as follows:
S21, establishing an expression for task execution time of the terminal device;
S22, establishing an expression for preparation time of the container instance of the edge server;
S23, establishing an expression for an optimal target function;
S24, establishing expressions for optimization problem constraints; and
S25, establishing, by satisfying the constraints in S24, a whole optimization problem with minimizing the expression for the target function in S23 as a target.

4. The joint optimization method for task offloading and container caching in a containerized edge computing system according to claim 3, wherein the expression for the task execution time of the terminal devices in S21 is specifically as follows:
$${τ}^{e} ( t ) = {\sum }_{i = 1}^{I} [ ( 1 - {\sum }_{j = 1}^{J} {x}_{i , j} ( t ) ) \frac{{D}_{i} ( t ) {ρ}_{i}}{{F}_{i}^{d}} + {\sum }_{j = 1}^{J} {x}_{i , j} ( t ) \frac{{D}_{i} ( t ) {ρ}_{i}}{{F}_{j}^{e}} ]$$
wherein τ^{e}(t) represents the task execution time of all the terminal devices; x_{i,j}(t) ∈{0,1} represents a task offloading decision; Dᵢ(t) represents a task load generated by a terminal device i during a time slot t; ρᵢ represents computational complexity of a task generated by the terminal device i;
$${F}_{i}^{d}$$
represents a computational frequency of the terminal device i;
$${F}_{j}^{e}$$
represents a computational frequency of the edge server j; I represents the number of the terminal devices; and J represents the number of the edge servers.

5. The joint optimization method for task offloading and container caching in a containerized edge computing system according to claim 4, wherein the preparation time of the container instance of the edge server in S22 comprises task offloading time, container instance starting time and container image file downloading time, the task offloading time of the terminal devices during the time slot t is expressed as:
$${τ}^{u} ( t ) = {\sum }_{j = 1}^{J} {\sum }_{i = 1}^{I} {x}_{i , j} ( t ) \frac{{D}_{i} ( t )}{{R}_{i , j}^{u}} \qquad ( 1 )$$
the container instance starting time of the edge server during the time slot t is expressed as:
$${τ}^{s} ( t ) = {\sum }_{j = 1}^{J} {\sum }_{i = 1}^{l} {x}_{i , j} ( t ) ( 1 - {y}_{i , j} ( t ) ) {\sum }_{s = 1}^{S} {ξ}_{i , s} {θ}_{s} \qquad ( 2 )$$
the container image file downloading time of the edge server during the time slot t is expressed as:
$${τ}^{d} ( t ) = {\sum }_{j = 1}^{J} {\sum }_{i = 1}^{I} {x}_{i , j} ( t ) ( 1 - {y}_{i , j} ( t ) ) ( 1 - {z}_{i , j} ( t ) ) \frac{{\sum }_{s = 1}^{S} {ξ}_{i , s} {λ}_{s}}{{R}_{j}^{d}} \qquad ( 3 )$$
wherein τ^{U}(t) represents the task offloading time of the terminal devices during the time slot t; I represents the number of the terminal devices; J represents the number of the edge servers; x_{i,j}(t) ∈{0,1} represents the task offloading decision; Dᵢ(t) represents the task load generated by the terminal device i during the time slot t;
$${R}_{i , j}^{u}$$
represents a transmission rate of the terminal device i during offloading the task to the edge server j; τ^{s}(t) represents the container instance starting time of the edge server during the time slot t; y_{i,j}(t) ∈{0,1} represents a container instance caching decision; ξ_{i,s} ∈{0,1} represents whether the task of the terminal device i requires an image file s; θₛ represents time of the image file s during starting the container instance; τ^{d} (t) represents the container image file downloading time of the edge server during the time slot t; z_{i,j}(t) ∈ {0,1} represents an image file caching decision; λₛ represents a size of the image file s;
$${R}_{j}^{d}$$
represents a rate of the edge server j during downloading the image file from the cloud server.

6. The joint optimization method for task offloading and container caching in a containerized edge computing system according to claim 5, wherein the expression for an optimal target function in S23 is specifically as follows:
$${τ}^{sum} ( t ) = {τ}^{e} ( t ) + {τ}^{u} ( t ) + {τ}^{s} ( t ) + {τ}^{d} ( t ) \qquad ( 4 )$$
wherein τ^{e}(t) represents the task execution time of all the terminal devices; τ^{u}(t) represents the task offloading time of the terminal devices during the time slot t; τ^{s}(t) represents the container instance starting time of the edge server during the time slot t; and τ^{d} (t) represents the container image file downloading time of the edge server during the time slot t.

7. The joint optimization method for task offloading and container caching in a containerized edge computing system according to claim 6, wherein the optimization problem constraints in S24 comprise a task offloading decision variable constraint, a cache capacity constraint of the container instance of the edge server, a cache capacity constraint of the container image file of the edge server, a caching decision logic constraint of the edge server and a 0-1 variable constraint;
the task offloading decision variable constraint is expressed as:
$${\sum }_{j = 1}^{1} {x}_{i , j} \leq 1 , ∀ i ∈ 𝕀$$
the cache capacity constraint of the container instance of the edge server is expressed as:
$${\sum }_{i = 1}^{I} {\sum }_{s = 1}^{S} {y}_{i , j} ( t ) {ξ}_{i , s} {η}_{s} \leq {η}_{j}^{max} , ∀ j ∈ 𝕁$$
the cache capacity constraint of the container image file of the edge server is expressed as:
$${\sum }_{i = 1}^{I} {\sum }_{s = 1}^{S} {z}_{i , j} ( t ) {ξ}_{i , s} {λ}_{s} \leq {λ}_{j}^{max} , ∀ j ∈ 𝕁$$
the caching decision logic constraint of the edge server is expressed as:
$$\begin{matrix}{y}_{i , j} ( t ) \leq {y}_{i , j} ( t - 1 ) + {x}_{i , j} ( t - 1 ) , ∀ i ∈ 𝕀 , j ∈ 𝕁 \\ {z}_{i , j} ( t ) \leq {z}_{i , j} ( t - 1 ) + {x}_{i , j} ( t - 1 ) ( 1 - {y}_{i , j} ( t - 1 ) ) , ∀ i ∈ 𝕀 , j ∈ 𝕁\end{matrix}$$
the 0-1 variable constraint is expressed as:
$${x}_{i , j} ( t ) , {y}_{i , j} ( t ) , {z}_{i , j} ( t ) ∈ \{ 0 , 1 \} , ∀ i ∈ 𝕀 , j ∈ 𝕁$$
wherein y_{i,j}(t) ∈{0,1} represents the container instance caching decision; ξ_{i,s} ∈{0,1} represents whether the task of the terminal device i requires the image file s; η₁ represents the size of RAM occupied by the container instance started by the image file s;
$${λ}_{j}^{max}$$
represents a maximal container instance cache capacity of the j^{th} edge server; z_{i,j}(t) ∈ {0,1} represents the image file caching decision; λₛ represents the size of the image file s;
$${η}_{j}^{max}$$
represents a maximal image file cache capacity of the j^{th} edge server; [symbol] ={1,2,3, . . . , I} represents a terminal device set; and [symbol] ={1,2,3, . . . , J} represents an edge server set.

8. The joint optimization method for task offloading and container caching in a containerized edge computing system according to claim 7, wherein solving the problem of nonlinear 0-1 programming in the Step 3 specifically comprises the process as follows:
S31, forming, by introducing three equality constraints, a new target function on the basis of the target function;
S32, transforming the three equality constraints into nine new inequality constraints by introducing equivalent transformation; and
S33, solving, by a solver or a linear integer programming algorithm, the transformed problem of linear 0-1 programming according to the new target function and the nine new inequality constraints in the Steps S31 and S32, in combination with six inequality constraints in an original target function.

9. The joint optimization method for task offloading and container caching in a containerized edge computing system according to claim 8, wherein the three equality constraints in S31 are specifically as follows:
$${p}_{i , j} ( t ) = {x}_{i , j} ( t ) {y}_{i , j} ( t ) \qquad ( 5 )$$
$${q}_{i , j} ( t ) = {x}_{i , j} ( t ) {z}_{i , j} ( t ) \qquad ( 6 )$$
$${l}_{i , j} ( t ) = {p}_{i , j} ( t ) {z}_{i , j} ( t ) \qquad ( 7 )$$
according to the formulas (1), (2), (3), (4), (5), (6) and (7), the new target function is obtained as follows:
$$\begin{matrix}{τ}^{{sum}^{'}} ( t ) = {\sum }_{i = 1}^{I} {A}_{i} ( t ) + {\sum }_{j = 1}^{J} {\sum }_{i = 1}^{I} {B}_{i , j} ( t ) {x}_{i , j} ( t ) + {\sum }_{j = 1}^{J} {\sum }_{i = 1}^{I} {C}_{i , j} ( t ) {p}_{i , j} ( t ) \\ + {\sum }_{j = 1}^{J} {\sum }_{i = 1}^{I} {D}_{i , j} ( t ) {q}_{i , j} ( t ) + {\sum }_{j = 1}^{J} {\sum }_{i = 1}^{I} {E}_{i , j} ( t ) {l}_{i , j} ( t ) \\ wherein {A}_{i} ( t ) = \frac{{D}_{i} ( t ) {ρ}_{i}}{{F}_{i}^{d}} , {B}_{i , j} ( t ) = - \frac{{D}_{i} ( C ) {ρ}_{i}}{{F}_{i}^{d}} + \frac{{D}_{i} ( C ) {ρ}_{i}}{{F}_{j}^{e}} + \frac{{D}_{i} ( t )}{{R}_{i , j}^{u}} + {\sum }_{s = 1}^{S} {ξ}_{i , s} {θ}_{s} + \frac{{\sum }_{s = 1}^{S} {ξ}_{i , s} {λ}_{s}}{{R}_{j}^{d}} , \\ {C}_{i , j} ( t ) = - {\sum }_{s = 1}^{S} {ξ}_{i , s} {θ}_{S} - \frac{{\sum }_{s = 1}^{S} {ξ}_{i , s} {λ}_{s}}{{R}_{j}^{d}} , {D}_{i , j} ( t ) = - \frac{{\sum }_{s = 1}^{S} {ξ}_{i , s} {λ}_{s}}{{R}_{j}^{d}} , {x}_{i , j} ( t ) ∈ \{ 0 , 1 \}\end{matrix}$$
represents the task offloading decision; y_{i,j}(t) ∈{0,1} represents the container instance caching decision; z_{i,j} (t) ∈{0,1} represents the image file caching decision; p_{i,j}, q_{i,j}, l_{i,j} ∈{0,1}, ∀i ∈ [symbol] , j ∈ [symbol] , [symbol] ={1,2,3, . . . , I} represents the terminal device set; [symbol] ={1,2,3, . . . , J} represents the edge server set.

10. The joint optimization method for task offloading and container caching in a containerized edge computing system according to claim 9, wherein equivalent transformation in S32 is specifically as follows: for any a, b, c ∈{0,1}, three inequality constraints c≤a, c≤b and a+b−1≤c are equivalent to an equality constraint c=a*b;
the nine new inequality constraints are specifically as follows:
$$\begin{matrix}{p}_{i , j} ( t ) \leq {x}_{i , j} ( t ) , ∀ i ∈ 𝕀 , j ∈ 𝕁 \\ {p}_{i , j} ( t ) \leq {y}_{i , j} ( t ) , ∀ i ∈ 𝕀 , j ∈ 𝕁 \\ {x}_{i , j} ( t ) + {y}_{i , j} ( t ) - 1 \leq {p}_{i , j} ( t ) , ∀ i ∈ 𝕀 , j ∈ 𝕁 \\ {q}_{i , j} ( t ) \leq {x}_{i , j} ( t ) , ∀ i ∈ 𝕀 , j ∈ 𝕁 \\ {q}_{i , j} ( t ) \leq {z}_{i , j} ( t ) , ∀ i ∈ 𝕀 , j ∈ 𝕁 \\ {x}_{i , j} ( t ) + {z}_{i , j} ( t ) - 1 \leq {q}_{i , j} ( t ) , ∀ i ∈ 𝕀 , j ∈ 𝕁 \\ {l}_{i , j} ( t ) \leq {p}_{i , j} ( t ) , ∀ i ∈ 𝕀 , j ∈ 𝕁 \\ {l}_{i , j} ( t ) \leq {z}_{i , j} ( t ) , ∀ i ∈ 𝕀 , j ∈ 𝕁 \\ {p}_{i , j} ( t ) + {z}_{i , j} ( t ) - 1 \leq {l}_{i , j} ( t ) , ∀ i ∈ 𝕀 , j ∈ 𝕁\end{matrix}$$
wherein x_{i,j}(t) ∈{0,1} represents the task offloading decision; y_{i,j}(t) ∈{0,1} represents the container instance caching decision; and z_{i,j}(t) ∈{0,1} represents the image file caching decision.
